(19) United States
(12) Patent Application Publication
(10) Pub. No.: US 2007/0171270 A1
(43) Pub. Date: Jul. 26, 2007

(54) THERMAL HEAD AND MANUFACTURING METHOD THEREOF

(75) Inventors: Tsuneyuki Sasaki, Fukushima-ken (JP); Hirotoshi Terao, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/622,386

(22) Filed: Jan. 11, 2007

(30) Foreign Application Priority Data
Jan. 12, 2006 (JP) 2006-004716

(51) Int. Cl. B41J 2/34

(52) U.S. Cl. 347/206

(57) ABSTRACT

A thermal head and a manufacturing method are provided. The thermal head includes an insulating head substrate, a heat insulating layer formed in the shape of a circular arc with a desired height and base dimension on a surface of the head substrate, heat radiating parts composed of resistive elements formed at an apex of the heat insulating layer. The surface of the head substrate is formed with a heat insulating layer forming part whose width is equal to the base dimension of the heat insulating layer. The heat insulating layer is formed with a predetermined height T on the heat insulating layer forming part. The curvature radius of the circular arc-shaped heat insulating layer in the vicinity of the heat radiating parts is set to a desired dimension.

This patent document claims the benefit of Japanese Patent Application No. 2006-004716 filed on Jan. 12, 2006, which is hereby incorporated by reference.

### BACKGROUND

1. Field

The present embodiments relate to a thermal head and a manufacturing method thereof.

2. Related Art

Conventionally, thermal transfer printers cause a plurality of heat radiating parts formed in a thermal head to selectively radiate heat based on printing information. The heat thermally transfers ink of an ink ribbon to print a desired image on a recording sheet. Thermal transfer printers are frequently used as an output apparatus of computers.

In a conventional thermal head used for the thermal transfer printer, as shown in FIG. 5, a head substrate 21, which is made of an insulating material, such as ceramic, and whose surface is formed flat is provided. In the vicinity of one end of the flat surface of the head substrate 21, a heat insulating layer 22, which protrudes in the shape of a circular arc, is formed with a predetermined height.

The heat insulating layer 22 is formed so as to protrude in the shape of a circular arc by heat-firing, for example, glass paste that is a material of the heat insulating layer at high temperature.

In the vicinity of an apex of the circular arc-shaped heat insulating layer 22, a plurality of heat radiating parts 23 composed of resistive elements is formed, and a plurality of individual electrodes (not shown) and a common electrode (not shown) to be connected to the heat radiating parts 23 are arranged on the right and left of the heat radiating parts 23.

Sealing resin, which seals a driver IC, is formed on the side of the other end of the head substrate 21 opposite to the side where the heat radiating parts 23 are formed such that it protrudes with a predetermined height.

The other end of the head substrate 21, which includes the sealing resin, is inclined during printing, so that it is possible to prevent occurrence of poor printing without abutment of the sealing resin on an ink ribbon to be conveyed during printing.

As for the printing operation of a thermal transfer printer using such a conventional thermal head, first, the thermal head is moved down to bring an ink ribbon (not shown) and a recording sheet (not shown) into pressure contract with a platen roller (not shown).

The ink on the ink ribbon is thermally transferred onto the recording sheet, thereby printing a desired image. The printing is performed by causing the plurality of heat radiating parts 23 to radiate heat on the basis of printing information, and rotating a sheet feeding roller (not shown).

Although high-speed printing has recently been strongly demanded in such a thermal transfer printer, the contact area between the heat insulating layer 22 as shown in FIG. 5 and the head substrate 21 is large. Thus, thermal capacity becomes large, which decreases thermal responsiveness.

When high-speed printing is performed using such a conventional thermal head, the ink ribbon and the recording sheet are conveyed before the heat insulating layer 22 is cooled down to a predetermined temperature. Therefore, unnecessary ink on the ink ribbon is thermally transferred to the recording sheet, which causes poor printing, such as a tailing phenomenon. Therefore, as shown in FIG. 6, a thermal head for high-speed printing, may include a heat insulating layer 24 having excellent thermal responsiveness by making the height T and base dimension W smaller than those in shown in FIG. 5, which reduces the cross-sectional area and thermal capacity.

[Patent Document 1] JP-A-2005-169855

[Patent Document 2] JP-A-5-305719

However, since the conventional thermal head is formed with the heat insulating layer 24 as shown in FIG. 6, which has excellent thermal responsiveness owing to small thermal capacity, even if the amount of glass paste that is the material of the heat insulating layer is reduced, a heat insulating layer 24′ as indicated by a broken line of FIG. 6 is formed in a state where the melted glass paste flows on the surface of the head substrate 21 at the time of heat-firing at high temperature, and consequently, the height become smaller than a desired height T, and the base dimension W′ becomes large.

Therefore, there is a problem in that the contact area between the heat insulating layer 24′ and the head substrate 21 becomes large, the thermal capacity becomes larger than that of the heat insulating layer 24 having a desired height T and width W, and the thermal responsiveness falls short of a desired value.

When the heat insulating layer 241 as indicated by the broken line of FIG. 6 is formed, the curvature radius of the circular arc-shaped heat insulating layer 24′ in the vicinity of the heat radiating parts 23 becomes too large, which affects printing quality.

### SUMMARY

The present embodiments may obviate one or more of the aforementioned problems. For example, in one embodiment, a thermal head is capable of forming a heat insulating layer having excellent thermal responsiveness, and setting the curvature radius of the heat insulating layer in the vicinity of heat radiating parts to a dimension, which does not affect printing quality.

In one embodiment, a thermal head includes an insulating head substrate, a heat insulating layer formed in the shape of a circular arc with a desired height and base dimension on a surface of the head substrate, heat radiating parts composed of resistive elements formed at an apex of the heat insulating layer.

The surface of the head substrate is formed with a heat insulating layer forming part whose width is equal to the base dimension of the heat insulating layer. The heat insulating layer is formed with a predetermined height on the heat insulating layer forming part. The curvature radius of the circular arc-shaped heat insulating layer in the vicinity of the heat radiating parts is set to a desired dimension.

In another embodiment, a thermal head has a heat insulating layer forming part formed so as to protrude with a desired width and height from the surface of the head substrate.

In another embodiment, the thermal head has a pair of grooves formed along the heat insulating layer forming part on both right and left sides of the heat insulating layer forming part having the desired width. The heat insulating layer is formed on a portion of the heat insulating layer forming part sandwiched between the pair of grooves.

In another embodiment, a method of manufacturing any one of the aforementioned thermal heads, in which the heat insulating layer is formed on the heat insulating layer forming part by heat-firing glass paste, and the heat insulating layer is formed so that the base dimension may be equal to the width of the heat insulating layer forming part and the curvature radius in the vicinity of the heat radiating parts may have a desired dimension, by forming the heat insulating layer so that the height may fall within a predetermined range by controlling the amount of the glass paste at the time of the formation of the heat insulating layer.

According to the present embodiments, the surface of the head substrate is formed with a heat insulating layer forming part whose width is equal to the base dimension of the heat insulating layer, the heat insulating layer is formed with a predetermined height on the heat insulating layer forming part, and the curvature radius of the circular arc-shaped heat insulating layer in the vicinity of the heat radiating parts is set to a desired dimension. Even if glass paste is heat-fired at the time of formation of a heat insulating layer, there is no case that the width of a heat insulating layer to be formed becomes larger than the width of a heat insulating layer forming part.

In one embodiment, a heat insulating layer with a desired width and height can be formed, a heat insulating layer having excellent thermal responsiveness can be formed, and a thermal head to cope with high-speed printing can be provided.

Since the heat insulating layer forming part is formed so as to protrude with a desired width and height from the surface of the head substrate, formation of the heat insulating layer forming part is easy. The thermal capacity of the heat insulating layer can be easily controlled by controlling the width of the heat insulating layer forming part.

A pair of grooves are formed along the heat insulating layer forming part on both right and left sides of the heat insulating layer forming part having the desired width, and the heat insulating layer is formed on a portion of the heat insulating layer forming part sandwiched between the pair of grooves. Thus, a heat insulating layer can be formed simply by forming a pair of grooves by grinding, or any suitable method. A thermal head, which is easy to manufacture, can be provided.

According to the method of manufacturing any one of the aforementioned thermal heads, the heat insulating layer is formed on the heat insulating layer forming part by heat-firing glass paste. The heat insulating layer is formed so that the base dimension may be equal to the width of the heat insulating layer forming part and the curvature radius in the vicinity of the heat radiating parts may have a desired dimension, by forming the heat insulating layer so that the height may fall within a predetermined range by controlling the amount of the glass paste at the time of the formation of the heat insulating layer. Thus, simply by controlling the amount of the glass paste, a heat insulating layer having excellent thermal responsiveness and a thermal head to cope with high-speed printing can be easily manufactured.

### BRIEF DESCRIPTION OF THE DRAWINGS

FIG. 1 is a cross-sectional view of essential parts of a thermal head according to a first embodiment;

FIG. 2 is an enlarged cross-sectional view of the parts of FIG. 1;

FIG. 3 is a cross-sectional view of parts of a thermal head according to a second embodiment;

FIG. 4 is a graph showing the relation among the curvature radius, base dimension, and height of a circular arc-shaped heat insulating layer;

FIG. 5 is a cross-sectional view illustrating a conventional thermal head; and

FIG. 6 is a cross-sectional view of essential parts illustrating the problems of the conventional thermal head.

### DETAILED DESCRIPTION

Hereinafter, embodiments of a thermal head and a manufacturing method thereof will be described with reference to the accompanying drawings.

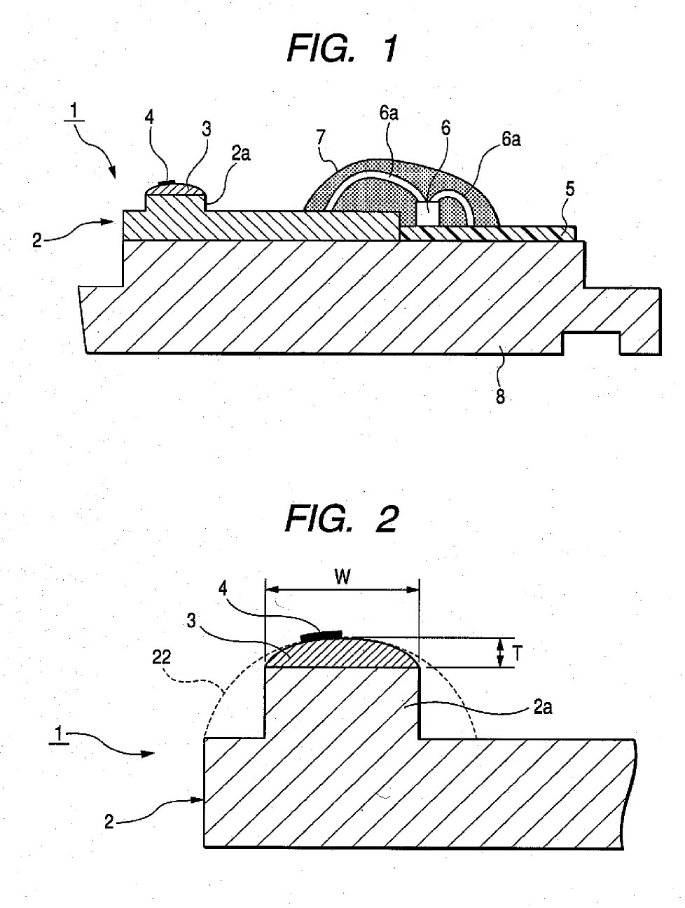

In one embodiment, as shown in FIG. 1, the thermal head 1 includes an insulating head substrate 2 formed of, for example, ceramic. The insulating head substrate 2 is formed along a direction orthogonal to the page.

In one embodiment, a heat insulating layer forming part 2a is protrudingly formed with a predetermined width W and height in a position in the vicinity of one end of the illustrated surface of the head substrate 2. The top face of the heat insulating layer forming part 2a is formed flat, and a heat insulating layer 3 having a circular arc-shaped cross-section and formed by heat-firing glass paste and is formed on the flat heat insulating layer forming part 2a.

In one embodiment, as shown in FIG. 2, the heat insulating layer 3 has a circular arc-shaped cross-section and a predetermined height T is formed on the heat insulating layer forming part 2a by heat-firing the head substrate 2 in a high-temperature atmosphere in a state where a predetermined amount of glass paste is applied on the top face of the flat heat insulating layer forming part 2a. The circular arc-shaped heat insulating layer 3 is formed such that the base dimension thereof is the same dimension as the width W of the heat insulating layer forming part 2a by the surface tension of the glass paste when being melted at a high temperature.

In one embodiment, the circular-arc shaped heat insulating layer 3 is formed such that the curvature radius in the vicinity of the apex thereof, as shown in FIG. 2, is approximately equal to the curvature radius in the vicinity of the apex of a heat insulating layer 22 of a conventional example indicated by a broken line, which becomes optimal for printing.

In one embodiment, as shown in FIG. 2, the heat insulating layer 3 has a smaller volume than the conventional heat insulating layer 22 indicated by a broken line, the heat insulating layer will have reduced thermal capacity, and consequently excellent thermal responsiveness.

The thermal capacity of the heat insulating layer 3 can be adjusted by adjusting the amount of glass paste to be applied onto the heat insulating layer forming part 2a formed with the width W to changing the height T.

The relation between the curvature radius of the heat insulating layer 3 and the base dimension W and height T becomes a result like a graph shown in FIG. 4, which was obtained from repeated experimental results.

For example, in a case where the heat insulating layer forming part 2a is formed to have a width of 0.9 mm, the heat insulating layer 3 having a curvature radius of 2.0 mm can be formed by applying glass paste onto the heat insulating layer forming part 2a with such an amount that the height T becomes 50 μm, and by heat-firing the glass paste at high temperature.

The heat insulating layer 3 having a curvature radius of 3.5 mm can be formed by applying glass paste onto the heat insulating layer forming part 2a with such an amount that the height T becomes 30 μm, and by heat-firing the glass paste. The heat insulating layer 3 having a desired curvature radius in the vicinity of a heat radiating part 4 can be formed by forming the heat insulating layer 3 such that the base dimension W and height T fall within a predetermined range shown in FIG. 4, by controlling the amount of the glass paste at the time of formation of the heat insulating layer 3.

A plurality of the heat radiating parts 4 composed of resistive elements are formed in the vicinity of the apex of the heat insulating layer 3 such that they are arranged linearly along a longitudinal direction of the head substrate 2.

A common electrode (not shown) is formed on the left (in the figure) of the heat radiating part 4, and individual electrodes are formed on the right (in the figure) of the heat radiating part. The common electrode and the individual electrodes are electrically connected to the heat radiating part.

Further, a printed board 5 is disposed on the right (in the figure) of the head substrate 2, and a driver IC 6, which can selectively control heat radiation of the plurality of heat radiating parts 4 is disposed on the top face of the printed board 5.

Lead wires 6a made of, for example, copper or aluminum, are connected to the driver IC 6, and the lead wires 6a are connected to the individual electrodes and a power-feeding pattern (not shown) formed on the printed board 5 by, for example, wiring bonding.

The driver IC 6 and the lead wires 6a is covered and sealed with sealing resin 7, such as thermosetting resin containing epoxy resin as its principal component.

The head substrate 2 and the printed board 5 are bonded to a head mount 8 made of metal having excellent heat radiation performance, such as aluminum, with adhesive having excellent thermal conductivity, such as silicon resin, thereby constituting the thermal head 1.

In one embodiment, a thermal head 1 is adapted to be able to move up and down with the head mount 8 attached to a thermal transfer printer. Also, by moving up the thermal head 1 toward a platen roller (not shown), an ink ribbon (not shown) and a recording sheet (not shown) which are conveyed between the thermal head 1 and the platen roller can be brought into pressure contact with the platen roller.

In one embodiment, a method of manufacturing a thermal head 1 is provided, the heat insulating layer forming part 2a having a width W is formed by, for example, photolithography so as to protrude with a predetermined height from the surface of the head substrate 2 made of, for example, ceramic.

The width W of the heat insulating layer forming part 2a can be obtained so as to correspond to a desired curvature radius from the graph shown in FIG. 4.

The circular arc-shaped heat insulating layer 3 is formed by applying glass paste onto the heat insulating layer forming part 2a with an amount corresponding to a desired curvature radius and thermal capacity, and by heat-firing the glass paste 2 at high temperature.

The plurality of heat radiating parts 4 are formed in the vicinity of an apex of the circular-arc shaped heat insulating layer by forming resistive elements on the heat insulating layer 3 formed as described above and then forming a common electrode and individual electrodes on the resistive elements, by, for example, a sputtering technique, or photolithography.

The head substrate 2, which includes the heat insulating layer 3 and the heat radiating part 4, is covered with a protective layer (not shown) having excellent wear resistance. The printed board 5 is bonded to the top face of the head mount 8 with adhesive having excellent heat conductivity, such as silicon adhesive, in a state where they are caused to abut on each other.

Thereafter, by applying a viscous liquid sealing resin 7 onto the driver IC 6 and lead wires 6a and curing the sealing resin, the driver IC 6, and the lead wires 6a are sealed, thereby manufacturing the thermal head 1.

In one embodiment, since the thermal head 1 is formed such that the width of the heat insulating layer 3 is equal to the width W of the heat insulating layer forming part 2a, the heat insulating layer 3 has reduced thermal capacity and thus has excellent thermal responsiveness and the circular arc in the vicinity of the heat radiating parts 4 can be formed to have a curvature radius that is optimal for printing, simply by controlling the amount of glass paste at the time of formation of the heat insulating layer 3.

In one embodiment, even if a thermal head 1 is loaded on a thermal transfer printer and this thermal transfer printer performs high-speed printing, a high-quality image can be printed.

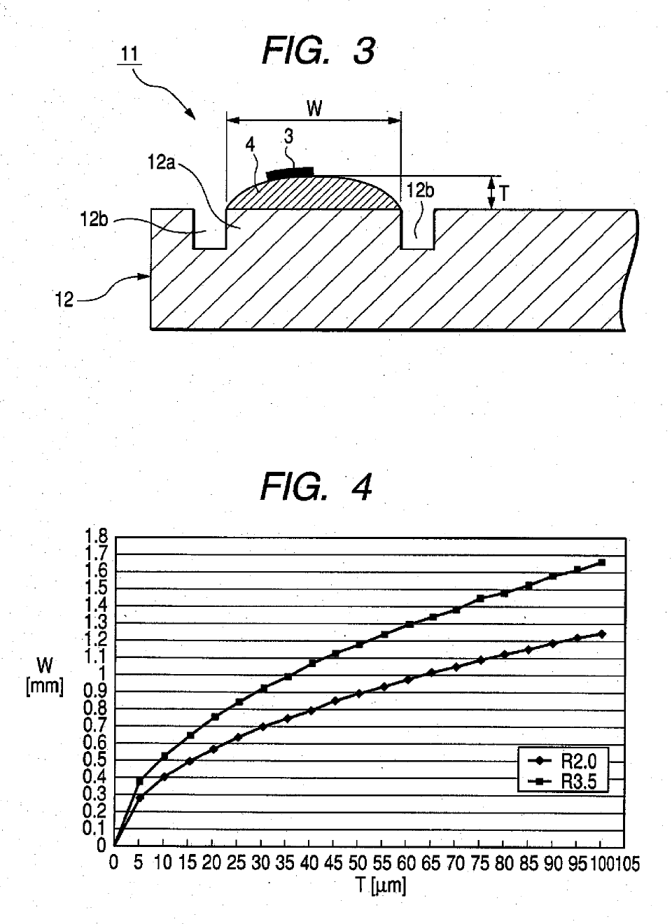

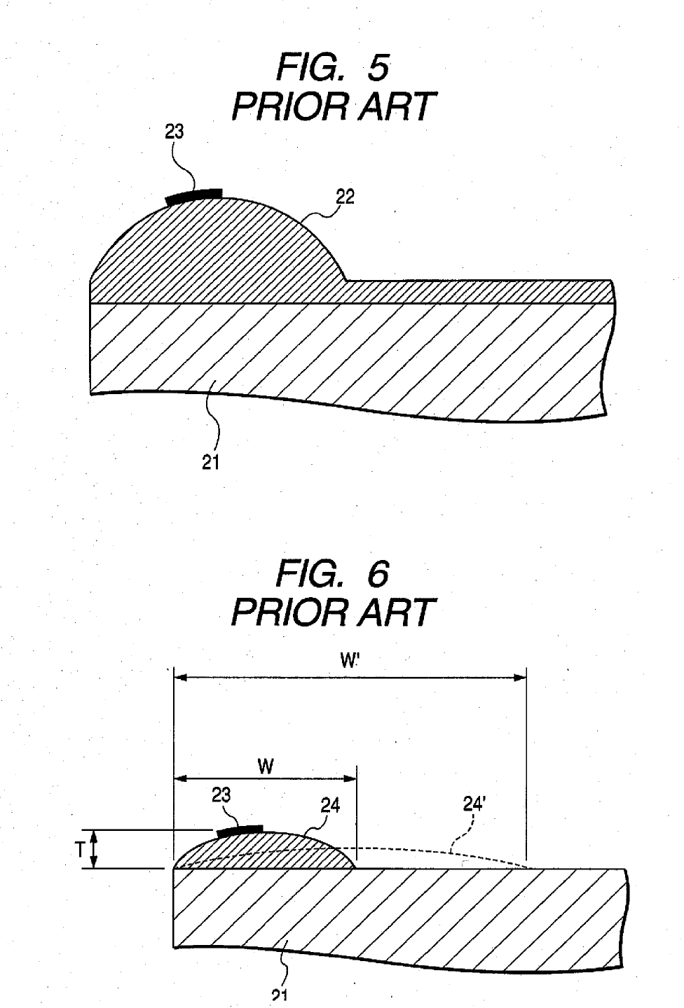

In one embodiment, as shown in FIG. 3, a thermal head 11 has a pair of grooves 12b and 12b with a predetermined width and depth that are formed on the surface of a flat head substrate 12 on both right and left sides of a heat insulating layer forming part 2a having a width W.

In one embodiment, a heat insulating layer 3 has a height T formed so as to protrude from the heat insulating layer forming part 12a having a width W, which is a portion sandwiched the pair of grooves 12a and 12b, and heat radiating parts 4 are formed in the vicinity of an apex of the circular arc-shaped heat insulating layer 3.

Since the configuration and manufacturing method of the heat insulating layer 3 and the heat radiating part 4 of the thermal head 11 of FIG. 3 is substantially the same as FIG. 1, the detailed description thereof will be omitted.

In one embodiment, the thermal head 11 including the heat insulating layer 3 has a base dimension equal to the width W of the heat insulating layer forming part 12a.

In this embodiment, the thermal head 11 can be easily manufactured because the heat insulating layer forming part 12a can be easily formed by grinding the pair of grooves 12b and 12b.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A thermal head comprising:
an insulating head substrate;
a heat insulating layer formed in the shape of a circular arc with a desired height and base dimension on a surface of the head substrate;
heat radiating parts composed of resistive elements formed at an apex of the heat insulating layer,
wherein the surface of the head substrate is formed with a heat insulating layer forming part whose width is equal to the base dimension of the heat insulating layer,
the heat insulating layer is formed with a predetermined height on the heat insulating layer forming part, and
the curvature radius of the circular arc-shaped heat insulating layer in the vicinity of the heat radiating parts is set to a desired dimension.

2. The thermal head according to claim 1,
wherein the heat insulating layer forming part protrudes with a desired width and height from the surface of the head substrate.

3. The thermal head according to claim 1,
wherein a pair of grooves are formed the heat insulating layer forming part on both right and left sides of the heat insulating layer forming part, and the heat insulating layer is formed on a portion of the heat insulating layer forming part sandwiched between the pair of grooves.

4. A method of manufacturing a thermal head, comprising:
forming a heat insulating layer on a heat insulating layer forming part by heat-firing glass paste,
forming the heat insulating layer so that the base dimension may be equal to the width of the heat insulating layer forming part and a curvature radius in the vicinity of the heat radiating parts may have a desired dimension, and
forming the heat insulating layer so that the height may fall within a predetermined range by controlling the amount of the glass paste at the time of the formation of the heat insulating layer.

5. The method of manufacturing the thermal head according to claim 4, comprising:
forming the heat insulating layer forming part so that it protrudes from the surface of the head substrate.

6. The method of manufacturing a thermal head according to claim 4, comprising:
forming a pair of grooves on the right and left of the heat insulating layer forming part, and the heat insulating layer is formed on a portion of the heat insulating layer forming part sandwiched between the pair of grooves.

7. A thermal head comprising:
an insulating head substrate;
a heat insulating layer disposed on a surface of the insulating head substrate;
heat radiating parts composed of resistive elements
wherein the surface of the head substrate is formed with a heat insulating layer forming part whose width is equal to the base dimension of the heat insulating layer.

8. The thermal head according to claim 7,
wherein the heat insulating layer is formed on the heat insulating layer forming part.

9. The thermal head according to claim 8,
wherein the curvature radius of the circular arc-shaped heat insulating layer in the vicinity of the heat radiating parts is set to a desired dimension.

10. The thermal head according to claim 7,
wherein the heat insulating layer forming part protrudes from the surface of the insulating head substrate.

11. The thermal head according to claim 7,
wherein a pair of grooves are disposed on both right and left sides of the heat insulating layer forming part, and the heat insulating layer is formed on a portion of the heat insulating layer forming part sandwiched between the pair of grooves.

12. The thermal head according to claim 7,
wherein the heat insulating layer is formed in the shape of a circular arc with a desired height and base dimension.

13. The thermal head according to claim 12,
wherein the radiating parts are formed at an apex of the heat insulating layer.
